(19) United States
(12) Patent Application Publication
(10) Pub. No.: US 2014/0023143 A1
(43) Pub. Date: Jan. 23, 2014

(54) REMOTE DISPLAY APPARATUS

(71) Applicant: MITSUBISHI ELECTRIC CORPORATION, Tokyo (JP)

(72) Inventor: Kenji Tsunashima, Tokyo (JP)

(21) Appl. No.: 13/915,010

(22) Filed: Jun. 11, 2013

(30) Foreign Application Priority Data
Jul. 23, 2012 (JP) 2012-162365

(51) Int. Cl. H04N 7/34

(52) U.S. Cl. CPC H04N 19/00763
USPC 375/240.16

(57) ABSTRACT

A remote display apparatus takes a display image generated for display on the display screen of an information processing device and displays it on the display screen of a digital television receiver connected to the information processing device through a network. The display image includes a still picture area and a moving picture area. Data representing the still picture area are sent to the digital television receiver as bit mapped data. Data representing the moving picture area are sent to the digital television receiver as a compressively encoded video stream. The digital television receiver does not require additional hardware.

### BACKGROUND OF THE INVENTION

1. Field of the Invention

This invention relates to a remote display apparatus for displaying, on the display screen of a digital television receiver, an image generated for display on the display screen of a personal computer (PC) or other information processing device connected to the digital television receiver through a network. In the following description, an image generated for display on an information processing device is also referred to as “display image of an information processing device”.

2. Description of the Related Art

With the growth of home and office networks it has been proposed to take the display image of, for example, a personal computer (PC) and display it on the display screen of a display device connected to the PC through a network (Japanese Patent Application Publication No. 2005-284195). The remote frame buffer (RFB) protocol is commonly used for this purpose. This protocol is basically intended, however, for transferring bit mapped data, and is not suitable for transferring moving pictures.

An efficient method of transferring moving pictures by extracting just the pixel data of areas in which the picture has changed and sending the data in a compressed form is disclosed in Japanese Patent Application Publication No. 2004-086550.

When the image to be displayed includes a moving picture, for rapid refreshing of the screen, the methods in both of the above Japanese patent applications entail an increased software load or the addition of special hardware, which may add to the cost of products in which these methods are used.

### SUMMARY OF THE INVENTION

An object of the present invention is, by displaying an image generated for display on the display screen of an information processing device on the display screen of a digital television receiver connected to the information processing device through a network, to enable, for example, an information processing device located in one place, e.g., one room to be operated from a digital television receiver located in another place, e.g., another room with a minimum of added software complexity, using the existing digital television receiver hardware.

A remote display apparatus according to a first aspect of the invention is for displaying, on a display screen of a digital television receiver connected to an information processing device through a network, a display image generated for display on a display screen of the information processing device, wherein:

the information processing device

compressively encodes a moving picture frame data in which pixel values of pixels in a moving picture area in the display image are retained and pixel values of pixels in an area of the display image other than the moving picture area are replaced with a predetermined fixed value, and

sends the encoded moving picture frame data as a video stream to the network, and

sends bit mapped data representing a still picture area of the display image to the network; and

the digital television receiver

receives the video stream and the bit mapped data from the network,

decodes the received video stream and reproduces the image in the moving picture area,

reproduces the image in the still picture area from the received bit mapped data, and

combines the reproduced image in the moving picture area and the reproduced image in the still picture area to obtain a combined image and displays the combined image on a display unit of the digital television receiver.

A remote display apparatus according to a second aspect of the invention is for displaying, on a display screen of a digital television receiver connected to an information processing device through a network, a display image generated for display on a display screen of the information processing device, wherein:

an image in a moving picture area included in the display image has been obtained in the information processing device by enlargement of an original image;

the information processing device

compressively encodes data representing the original image and sends the encoded data to the network as a video stream, and

sends data representing a still picture area of the display image to the network as bit mapped data; and

the digital television receiver

receives the video stream and the bit mapped data from the network,

decodes the received video stream and enlarges the decoded stream by use of a picture-in-picture function, thereby reproducing the image in the moving picture area,

reproduces the image in the still picture area from the received bit mapped data, and

combines the reproduced image in the moving picture area and the reproduced image in the still picture area to obtain a combined image and displays the combined image on a display unit of the digital television receiver.

A remote display apparatus according to a third aspect of the invention is for displaying, on a display screen of a digital television receiver connected to an information processing device through a network, a display image generated for display on a display screen of the information processing device, wherein:

the information processing device

decides whether an image in a moving picture area included in the display image has been obtained by enlargement of an original image in the information processing device;

compressively encodes data representing the original image and sends the encoded data to the network as a video stream, when the image in the moving picture area has been obtained by enlargement of the original image,

compressively encodes data representing the image in the moving picture area and sends the encoded data to the network as the video stream, when the image in the moving picture area has been obtained without enlargement of the original image, and

sends data representing a still picture area of the display image to the network as bit mapped data; and

the digital television receiver

receives the video stream and the bit mapped data from the network,

decodes the received video stream and enlarges the decoded stream by use of a picture-in-picture function, thereby reproducing the image in the moving picture area, when the image in the moving picture area has been obtained by enlargement of the original image,

decodes the received video stream, thereby reproducing the image in the moving picture area, when the image in the moving picture area has been obtained without enlargement of the original image,

reproduces the image in the still picture area from the received bit mapped data, and

combines the reproduced image in the moving picture area and the reproduced image in the still picture area to obtain a combined image and displays the combined image on a display unit of the digital television receiver.

According to this invention, the display image of an information processing device (image generated for display on an information processing device) can be displayed on the display screen of a digital television receiver without adding hardware to the digital television receiver, even if the display image includes a moving picture.

### BRIEF DESCRIPTION OF THE DRAWINGS

In the attached drawings:

FIG. 1 is a block diagram showing the overall configuration of a remote display apparatus in a first embodiment of the invention;

FIG. 2 is a block diagram showing the configuration of the PC in FIG. 1;

FIG. 3 is a block diagram showing a configuration for implementing the functions of the area discriminator, separator, video encoder, bitmap output unit, and control unit in FIG. 2, together with the display image generator, display unit, and network interface;

FIG. 4 is a block diagram showing the configuration of the digital television receiver in FIG. 1;

FIGS. 5A to 5D are conceptual diagrams illustrating the flow of processing in the remote display apparatus shown in FIGS. 2 and 4;

FIG. 6 is a block diagram showing the configuration of the PC in a remote display apparatus in a second embodiment of the invention;

FIG. 7 is a block diagram showing the configuration of the digital television receiver in the remote display apparatus in the second embodiment of the invention;

FIG. 8A to 8F are conceptual diagrams illustrating the flow of processing in the remote display apparatus shown in FIGS. 6 and 7;

FIG. 9 is a block diagram showing the configuration of the PC in a remote display apparatus in a third embodiment of the invention; and

FIG. 10 is a block diagram showing the configuration of the digital television receiver in the remote display apparatus in the third embodiment of the invention.

### DETAILED DESCRIPTION OF THE INVENTION

### First Embodiment

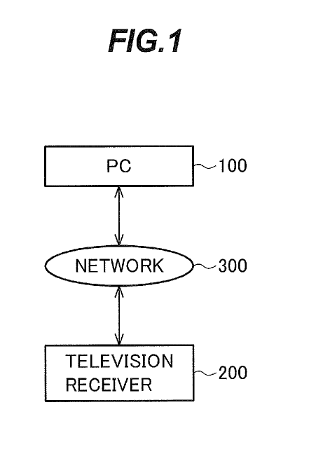

FIG. 1 shows a remote display apparatus in a first embodiment of the invention, in which a PC 100 and a digital television receiver 200 are connected through a network 300. The PC 100 is one example of an information processing device.

The PC 100 is disposed in one place, for example in one room, e.g., in a study in a house; the digital television receiver 200 is disposed in another place, for example in another room, e.g., in the living room.

In the remote display apparatus shown in FIG. 1, the PC 100 sends screen data representing an image generated for display on its display screen (a display image of the display screen) to the digital television receiver 200, and the image is displayed on the display screen of the digital television receiver 200.

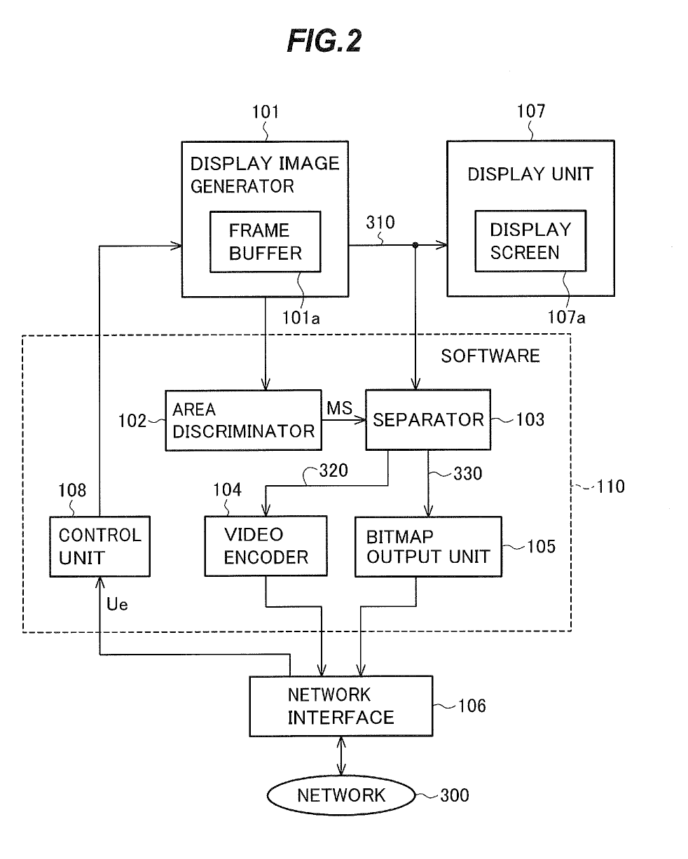

As shown in FIG. 2, the PC 100 includes a display image generator 101, an area discriminator 102, a separator 103, a video encoder 104, a bitmap output unit 105, a network interface 106, a display unit 107, and a control unit 108.

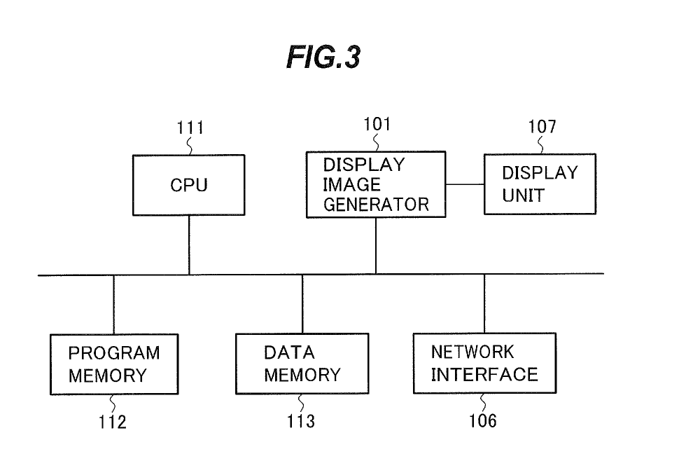

Of the above components, the area discriminator 102, separator 103, video encoder 104, bitmap output unit 105, and control unit 108 are implemented by software 110, that is, by a programmed computing device. As shown in FIG. 3, the PC 100 includes a central processing unit (CPU) 111, a program memory 112, and a data memory 113 in addition to the display image generator 101, display unit 107, and network interface 106. The CPU 111 executes a program stored in the program memory 112 to implement the functions of the area discriminator 102, separator 103, video encoder 104, bitmap output unit 105, and control unit 108. Data, results of calculations, and the like generated when the program is executed by the CPU 111 are stored temporarily in the data memory 113.

The display image generator 101 generates screen data, i.e., image data representing a display image for display on the display screen 107a of the display unit 107. The display image may include only a moving picture or only a still picture, or may include a moving picture in one part and a still picture in another part.

The display image generator 101 is configured as a graphics processing circuit in the PC 100. This circuit includes a frame buffer 101a, which stores a frame of image data representing the display image on the display screen 107a of the display unit 107.

The area discriminator 102 takes the data representing the display image generated by the display image generator 101 and decides whether each part of the display image in each frame constitutes a moving picture.

The separator 103 separates the display image into two parts: the part decided (found) to constitute a moving picture (moving picture area) by the area discriminator 102 and the other part (still picture area).

The video encoder 104 generates encoded data by compressively encoding the image data in the moving picture area separated by the separator 103 and outputs the data as a video stream.

The bitmap output unit 105 outputs the image data in the still picture area as bit mapped data.

The network interface 106 sends the image data in the moving picture area output from the video encoder 104 and the image data in the still picture area output from the bitmap output unit 105 to the network 300.

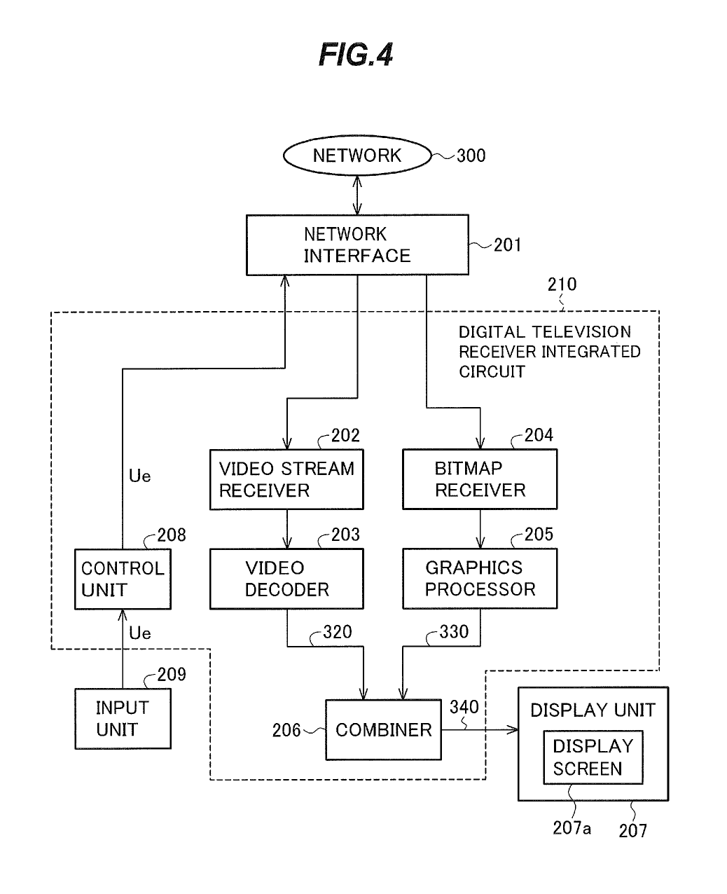

As shown in FIG. 4, the digital television receiver 200 includes a network interface 201, a video stream receiver 202, a video decoder 203, a bitmap receiver 204, a graphics processor 205, a combiner 206, a display unit 207, a control unit 208, and an input unit 209.

The network interface 201 receives image data sent from the PC 100 through the network 300.

The video stream receiver 202 extracts the image data in the moving picture area (the video stream generated by compressive encoding) from the image data received by the network interface 201 and supplies the image data to the video decoder 203.

The video decoder 203 decodes the image data in the moving picture area received by the video stream receiver 202.

The bitmap receiver 204 extracts the image data in the still picture area (the bit mapped data) from the image data received by the network interface 201 and supplies the image data to the graphics processor 205.

The graphics processor 205 converts the image data in the still picture area received by the bitmap receiver 204 to data in a format suitable for display on the display screen 207a of the digital television receiver 200.

The combiner 206 combines the output of the video decoder 203 and the output of the graphics processor 205 to generate screen data representing an image for display on the display screen 207a of the display unit 207 of the digital television receiver 200 (television display image) and supplies the data to the display unit 207.

The display unit 207 displays an image corresponding to the data supplied from the combiner 206.

The video stream receiver 202, video decoder 203, bitmap receiver 204, graphics processor 205, and control unit 208 are configured as a digital television receiver integrated circuit (DTV decoder chip) 210.

The input unit 209 generates a signal corresponding to user input.

User input is performed in accordance with a graphical user interface (GUI) included in the display image on the display screen 207a.

The signal Ue corresponding to the user input (user event) is input to the control unit 208, which sends the signal through the network interface 201 to the network 300. In the PC 100, the network interface 106 receives the signal Ue representing the user input and sends it to the control unit 108, which controls each part of the PC 100 according to the signal Ue. As part of the control, the display image generator 101 is controlled to modify the image to be generated by the display image generator 101. For example, when the user input is the pressing of a button on a displayed menu selection screen to select one of the options on the menu, a screen may be displayed prompting the user to perform a further operation responsive to selection of the option. By repetition of such steps, the PC 100 is remotely operated by the input unit 209.

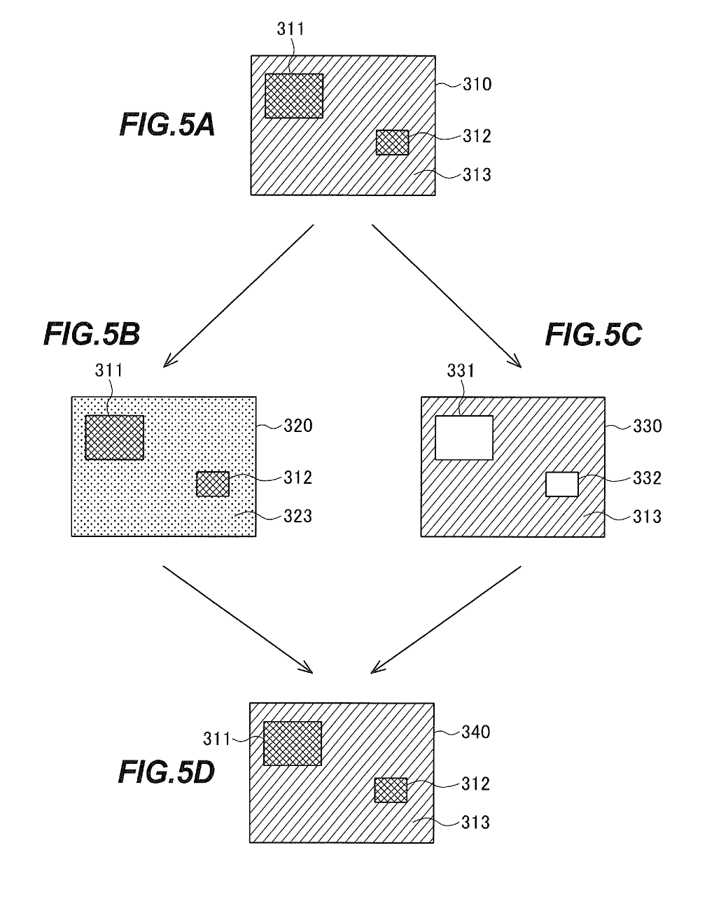

The operation of the remote display apparatus will be described in detail below with reference to FIGS. 5A to 5D.

FIG. 5A shows an exemplary image generated by the display image generator 101 and stored in the frame buffer 101a. The illustrated image 310 includes moving picture areas 311, 312 and a still picture area 313, i.e., an area other than the moving picture areas.

The area discriminator 102 reads image data stored in the frame buffer 101a, decides whether each area in the image represented by the image data is a moving picture area (moving picture part) or not, and outputs information MS indicating a result of the decision. Frame buffer addresses, i.e., information indicating the position of the parts decided to be moving picture areas may be output as the information MS.

Any of a variety of proposed methods may be used to decide whether each area in the image is a moving picture area or not.

For example, the difference in pixel data between identical display positions in consecutive frames may be calculated, and an area including many pixels for which a difference exceeding a predetermined level has been calculated may be designated as a moving picture area.

In this process, the screen may be divided into a plurality of rectangular parts, the proportion of pixels for which the absolute value of the above difference exceeds a predetermined level may be determined for each part, and the part may be designated as a moving picture area if this proportion is higher than a predetermined value.

When the display image generator 101 generates the display image data by combining a moving picture and a still picture, which are externally supplied, if additional information indicating whether each supplied picture is a moving picture or a still picture is supplied together with moving picture image data and still picture image data, the additional information may be sent to the area discriminator 102, which then uses the additional information to decide whether each part of the combined image is a moving picture area or not.

In this process, if the screen may be divided into a plurality of rectangular parts, a decision as to whether each rectangular part is a moving picture area or not may be made on the basis of the additional information.

The separator 103 separates the display image of each frame (display screen) into moving picture areas, i.e., parts decided to be a moving picture by the area discriminator 102 and other parts (still picture areas), and generates moving picture frame data 320 (FIG. 5B) containing the image data of the moving picture areas and still picture frame data 330 (FIG. 5C) containing the image data of the still picture areas.

The moving picture frame data 320 consist of pixel values of the pixels in the detected moving picture areas 311, 312 having been retained, and pixel values of the pixels in the still picture area 313 having been replaced with a predetermined fixed value. The area generated by this replacement is designated by reference numeral 323.

The still picture frame data 330 consist of pixel values of the pixels in the still picture area 313 having been retained, and pixel values of the pixels in the moving picture areas 311, 312 having been replaced with a value that, in graphics data, corresponds to a transparent area. The areas generated by this replacement are designated by reference numerals 331, 332.

The image represented by the moving picture frame data 320 and the image represented by the still picture frame data 330 have the same size (the same number of pixels) as the image on the display screen 107a of the PC 100.

The moving picture frame data 320 in FIG. 5B are compressively encoded by the video encoder 104, generating an encoded screen. Data representing the encoded screen are stored in a frame buffer formed of a memory area in the data memory 113 and sent as an encoded video stream through the network interface 106 to the network 300.

The video encoder 104 performs compression by a method that allows the video decoder 203 in the digital television receiver 200 to decode the data.

As part of the digital television receiver integrated circuit 210, digital television receivers generally include decoder hardware supporting the MPEG-2 compression method used in digital broadcasting. Since a hardware decoder is used as the video decoder 203 in FIG. 4, the video encoder 104 preferably performs MPEG-2 encoding.

It is desirable to use the MPEG-2 TS (transport stream) streaming method because then the digital television receiver 200 can display the moving picture by performing the same decoding process as in receiving a broadcast.

The still picture frame data 330 (FIG. 5C) output from the separator 103 are converted by the bitmap output unit 105 to data representing a bit mapped image in a format suitable for network transmission, stored in the data memory 113, sent through network interface 106 to the network 300, and then sent through network interface 201 to the bitmap receiver 204 in the digital television receiver 200.

As the format of the bit mapped image data generated by the display image generator 101, a color format including an opacity (alpha) channel, such as ARGB32 (eight bits each in the alpha, red, green, and blue channels) or ARGB1555 (one bit in the alpha channel and five bits each in the red, green, and blue channels) is used. A value indicating full transparency (alpha value 0) may be set for the moving picture areas 311, 312.

If the above color formats cannot be used, the still picture frame data may be generated by having the pixel value of each pixel in the moving picture area replaced with a value representing a predetermined color, and may then be supplied from the bitmap output unit 105 through the network interfaces 106, 201, bitmap receiver 204, and graphics processor 205 to the combiner 206. When this pixel value is received from the graphics processor 205 for each pixel in the moving picture area, the combiner 206 makes the corresponding parts transparent and displays the moving picture represented by the output of the video decoder 203. This technique is known as chroma key compositing.

The bit mapped image data can be transferred through the network by the remote frame buffer (RFB) protocol, for example, by installing a software package known as Virtual Network Computing (VNC).

In this embodiment, the VNC server is installed on the PC 100, and the VNC client is installed on the digital television receiver 200. A graphical user interface (GUI) generated by the PC 100 are sent, as part of the bit mapped data, through the network to the digital television receiver 200. The digital television receiver 200 displays a screen corresponding to the GUI on the display unit 207 and returns to the PC 100 signals corresponding to user input from the input unit 209, thereby performing remote operation of the PC 100.

In this embodiment, in addition to control buttons on the main unit of the digital television receiver and a remote control unit that sends infrared signals to a receiving section (not shown) in the main unit, it is envisaged that a keyboard and mouse are connected as the input unit 209 of the digital television receiver 200. To connect a keyboard or mouse, a corresponding driver must be installed on the processor constituting the control unit 208 of the digital television receiver 200.

Since the GUI on the PC screen, which normally consists of buttons or the like, is generally transferred as bit mapped data, separation of moving picture areas does not affect the VNC operation. If an input unit 209 including a keyboard or a mouse connected to the digital television receiver 200 is connected, the user can perform operations such as selecting a moving picture to be reproduced while viewing the screen of the digital television receiver 200.

In the digital television receiver 200, the video stream receiver 202 and the bitmap receiver 204 respectively take, from the network interface 201, the image data in the moving picture area output from the video encoder 104 and the image data in the still picture area output from the bitmap output unit 105, which arrive via the network 300, and supply the respective image data to the video decoder 203 and the graphics processor 205.

The video decoder 203 draws an image corresponding to the image data in the moving picture areas on the display screen 207a of the digital television receiver 200, in the positions corresponding, within the whole screen, to the moving picture areas (areas 311, 312 in FIG. 5B) to reproduce the same screen data as shown in FIG. 5B.

The graphics processor 205 draws a picture corresponding to the bit mapped data in the still picture area on the display screen 207a of the digital television receiver 200, in the positions within the screen as a whole corresponding to the still picture area (still picture area 313 in FIG. 5C), to reproduce the same screen content as shown in FIG. 5C.

The combiner 206 combines the output of the video decoder 203 and the output of the graphics processor 205 into a combined image 340 (FIG. 5D). The combined image is supplied to the display unit 207 and displayed on the display screen 207a of the display unit 207.

Since the moving picture areas are placed in the original positions (positions corresponding to the positions on the PC screen), the original image generated for display on the PC screen can be reproduced just by superimposing the image output from the video decoder 203 and the bit mapped image output from the graphics processor 205, with coordinate positions being aligned.

In the resulting combined image, the data in the moving picture areas 331, 332 on the screen shown in FIG. 5B have been taken and placed in the transparent moving picture areas 311, 312 in the screen shown in FIG. 5C.

If the size or the number of pixels of the display screen 207a of the digital television receiver 200 differs from that of the display screen 107a of the PC 100, scaling is performed.

Scaling may be performed after the images are combined by the combiner 206, or scaling may be performed separately for the moving picture area and the still picture area before the images are combined.

The digital television receiver integrated circuit 210 normally has a scaling function.

All processing performed by the digital television receiver 200 can be performed by integrated circuits generally included in commercial digital television receivers and can be implemented without additional hardware.

Use of software for performing compressive encoding based on the MPEG-2 standard in the video encoder 104 enables the MPEG-2 decoder in the digital television receiver integrated circuit 210 to be used, so moving pictures can be reproduced without additional hardware.

Bit mapped images can be easily provided by having the control unit 208 for controlling the digital television receiver execute a graphics function for an on-screen display (OSD) or the like.

The configuration shown in FIG. 4 can be implemented by partly modifying the software of a conventional digital television receiver or by adding further software.

The area discriminator 102, separator 103, video encoder 104, and bitmap output unit 105 of the PC 100 can be implemented by software alone, as described above.

In particular, bit mapped data can be sent and received easily with widely used VNC software. If a mouse and/or a keyboard is connected to the digital television receiver 200 by the VNC function, the user can control the PC 100 while viewing, on the display unit 207 of the digital television receiver 200, the image originally generated for display on the display unit 107 of the PC 100.

GUI buttons and the like on the display screen 207a are located in an area other than the moving picture area and are sent as bit mapped data. Changes in the display image on the PC caused by user input will accordingly not be affected by delays caused by the moving picture encoding and the like. The displayed image changes in response to user input with little delay at all.

### Second Embodiment

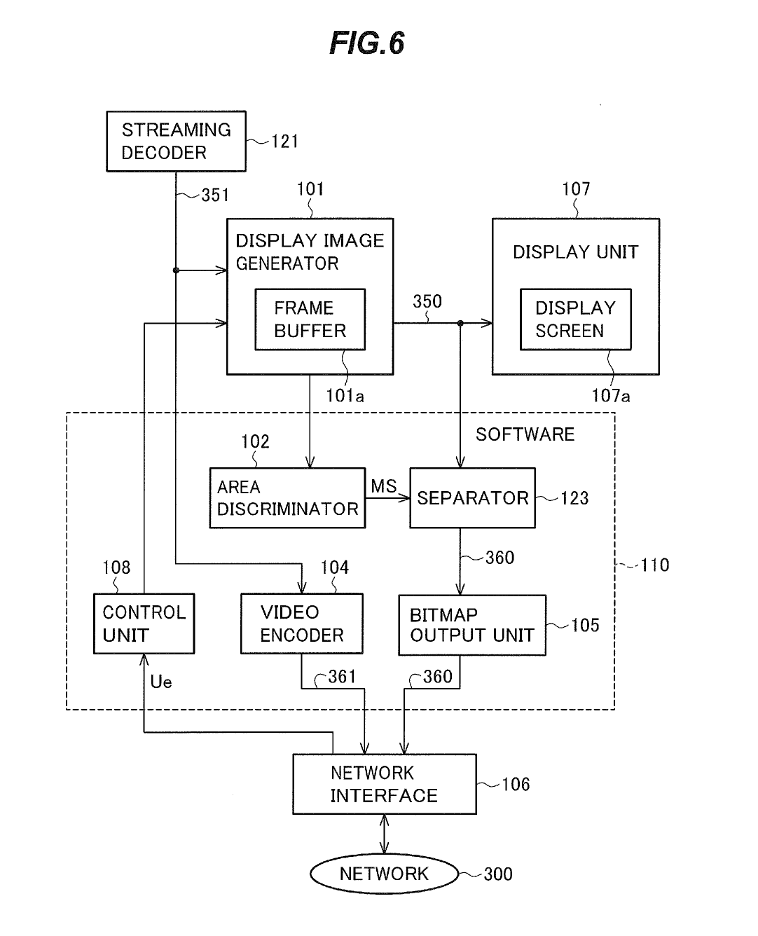

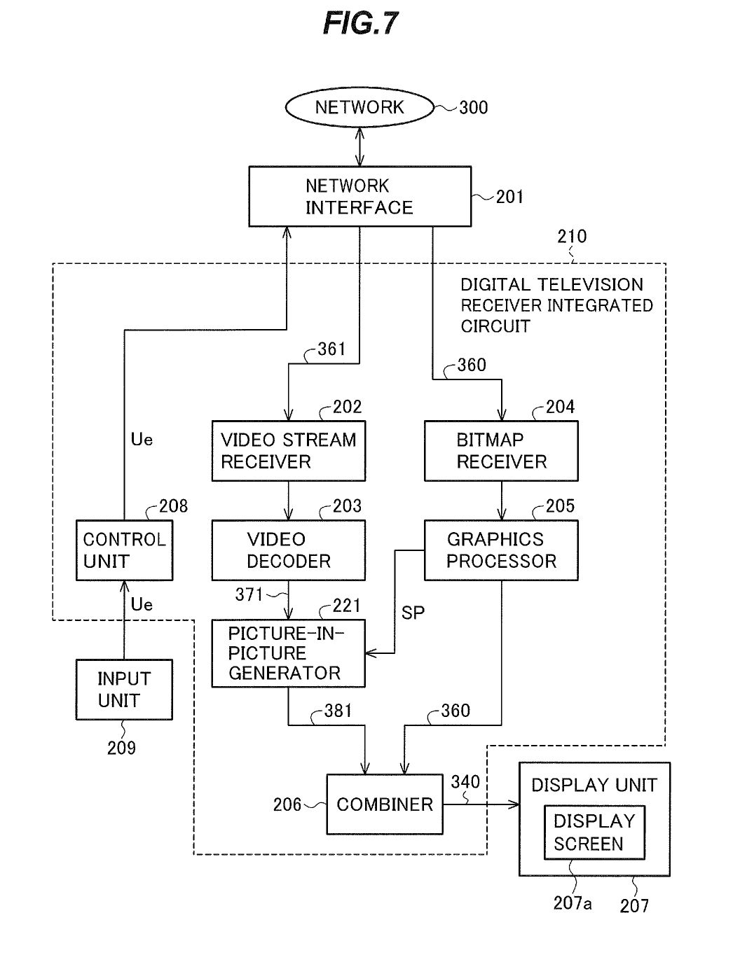

FIGS. 6 and 7 show the PC 100 and digital television receiver 200 in a remote display apparatus in a second embodiment of the invention.

The PC 100 and digital television receiver 200 in these drawings are generally similar to the PC 100 and digital television receiver 200 in the first embodiment, described with reference to FIGS. 2 and 4, but differ in that a streaming decoder 121 is added to the PC 100, a picture-in-picture generator 221 is added to the digital television receiver 200, and the separator 103 in FIG. 2 is replaced by a different separator 123.

When a moving picture is displayed on a PC screen, the moving picture may have been sent from an external source and enlarged by the display image generator 101. When the enlarged image is so large that it occupies nearly the entire screen area, the processing in the first embodiment would place a heavy load on the video encoder 104. In the second embodiment, the processing load on the video encoder 104 is reduced so that, even if the performance of the CPU 111 that implements the processing of the video encoder 104 etc. is low, an image containing a moving picture area and a still picture area can be displayed on the digital television receiver without changing the hardware configuration of the digital television receiver, as in the first embodiment.

FIG. 6 is a block diagram of the PC 100 and FIG. 7 is a block diagram of the digital television receiver 200 in the remote display apparatus in the second embodiment. Elements that are the same as in FIGS. 2 and 4 are denoted by the same reference characters.

The streaming decoder 121 receives a stream of data representing a video picture sent through a network such as the Internet, and decodes the data.

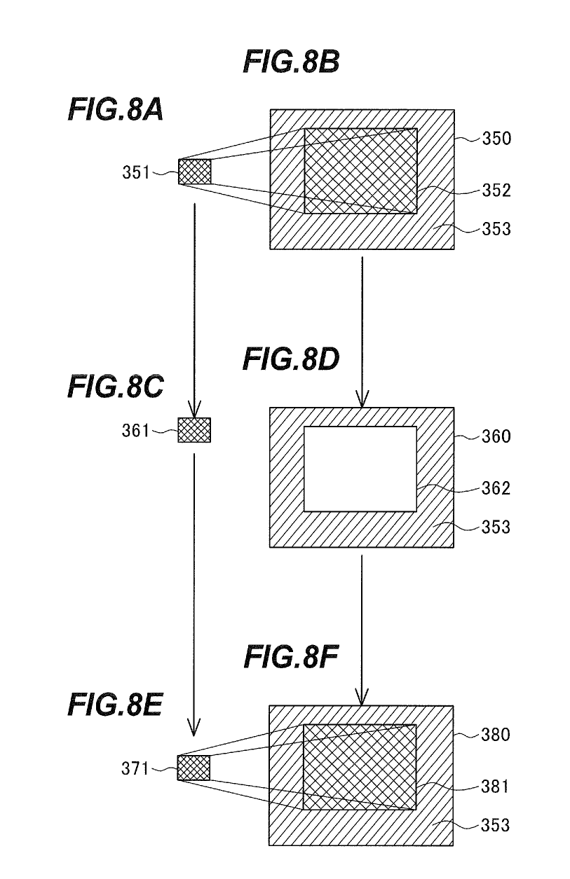

The output 351 (FIG. 8A) of the streaming decoder 121 is supplied to the display image generator 101 and directly to the video encoder 104.

The moving picture data 351 (FIG. 8A) supplied to the display image generator 101 are combined with separately generated bit mapped data to generate a combined image 350 (FIG. 8B). When these data are combined, the moving picture data 351 are enlarged to occupy an area 352, as shown in FIG. 8B, and the bit mapped image is placed in the area 353 other than the area 352 occupied by the moving picture. In the example shown in FIG. 8B, the area 353 of the bit mapped image surrounds the rectangular area 352 occupied by the enlarged moving picture.

When video is sent through the Internet, sufficient transmission bandwidth is not always available, so video is often transmitted with a significantly lower resolution than the display resolution of the PC screen and is frequently displayed after enlargement by the graphics function of the display image generator 101 of the PC 100. The enlarged image data are stored in the frame buffer 101a.

In comparison with the encoding of the image at its original size, encoding of the image data in the moving picture area of the content read from the frame buffer 101a of the display image generator 101 places a heavier processing load on the video encoder 104 and this may lead to degradation of picture quality.

This problem is prevented in this embodiment by sending data representing the moving picture before enlargement to the video encoder 104 for encoding. The software of the PC 100 is modified to supply the data representing the moving picture before enlargement to the video encoder 104 and not to generate, in the separator 123, image data (the “moving picture frame data” in the first embodiment) in which the pixel values of the pixels in the moving picture area are retained.

The video encoder 104 compressively encodes the image data (FIG. 8A) representing the moving picture supplied from the streaming decoder 121 to generate a video stream 361 (FIG. 8C).

The network interface 106 sends the video stream 361 (FIG. 8C) to the network 300.

The area discriminator 102 decides whether each part of the image represented by the image data output from the display image generator 101 constitutes a moving picture. The decision can be made on the basis of layout data obtained from the display image generator 101, indicating the position of the area on the screen into which the image supplied from the streaming decoder 121 is placed after enlargement by the display image generator 101.

The separator 123 extracts a still picture area in accordance with a result of the decision made by the area discriminator 102. Still picture frame data 360 (FIG. 8D) are generated by replacing pixel values of the pixels in the moving picture area 352 with a value that, in graphics data, corresponds to a transparent area, and forming the remaining area 353 of the pixels of the original pixel values. The area in which the pixel values have been replaced is denoted by reference numeral 362.

The bitmap output unit 105 converts the still picture frame data 360 separated by the separator 123 to data in a format suitable for network transmission and sends the data through the network interface 106 to the network 300.

The output of the video encoder 104 and the output of the bitmap output unit 105 sent to the network 300 are received by the network interface 201 of the digital television receiver 200.

The video stream receiver 202 extracts the output of the video encoder 104 from the data received by the network interface 201 and supplies it to the video decoder 203.

The bitmap receiver 204 extracts the output of the bitmap output unit 105 from the data received by the network interface 201 and supplies it to the graphics processor 205.

The image data in the still picture area received by the bitmap receiver 204 are supplied to the graphics processor 205.

The graphics processor 205 draws an image corresponding to the image data (bit mapped data) in the still picture area on the display screen 207a of the digital television receiver 200, in the position corresponding, within the whole screen, to the still picture area 353 (FIGS. 8B and 8D), thereby reproducing the same screen content (data representing the same screen content) as that shown in FIG. 8D.

The video decoder 203 decodes the video stream 361 (FIG. 8C) to reproduce a picture 371 (FIG. 8E) having the same content as the moving picture data 351 (FIG. 8A) represented by the output of the streaming decoder 121.

The output 371 of the video decoder 203 is supplied to the picture-in-picture generator 221.

The picture-in-picture generator 221 has a function of generating the sub-picture in a picture-in-picture (PIP). That is, the picture-in-picture generator 221 enlarges the image represented by the output of the video decoder 203 to the same size as the moving picture area 352 (FIG. 8B) on the PC screen, i.e., the same size as the transparent area 362 in the still picture frame data, and positions the image on the screen so as to match the position of the transparent area 362 in the still picture frame data. The enlargement ratio is calculated from the size of the picture 371 and the size of the transparent area 362. Information SP indicating the size and position of the transparent area 362 is supplied from the graphics processor 205. Alternatively, information indicating the position of the moving picture area 352 and the enlargement ratio used by the display image generator 101 of the PC 100 to enlarge the moving picture and generate the combined image 350 may be sent from the PC 100 to the digital television receiver 200 and may be used in the picture-in-picture generator 221.

The combiner 206 combines the moving picture generated by the picture-in-picture generator 221 and the still picture output from the graphics processor 205 to generate a combined image 380 (FIG. 8F).

In the resulting combined image, the image generated (enlarged and positioned) by the picture-in-picture generator 221 is placed in the transparent area 362 (the transparent part) in the image shown in FIG. 8D. The image generated and inserted by the picture-in-picture generator 221 in the combined image is designated by reference numeral 381.

Many digital television receivers have a PIP function.

PIP displays one of two source pictures on the full screen and displays the other picture as a sub-screen in one part of the full screen. The display image of the PC 100 is reproduced by using this function to enlarge the incoming moving picture to a given size and combine the enlarged picture with the screen representing the bit mapped data.

In the second embodiment, an image including a moving picture generated for display on the PC screen can be displayed on the screen of the digital television receiver by using the PIP function supported by many digital television receivers, without adding special hardware or software.

### Third Embodiment

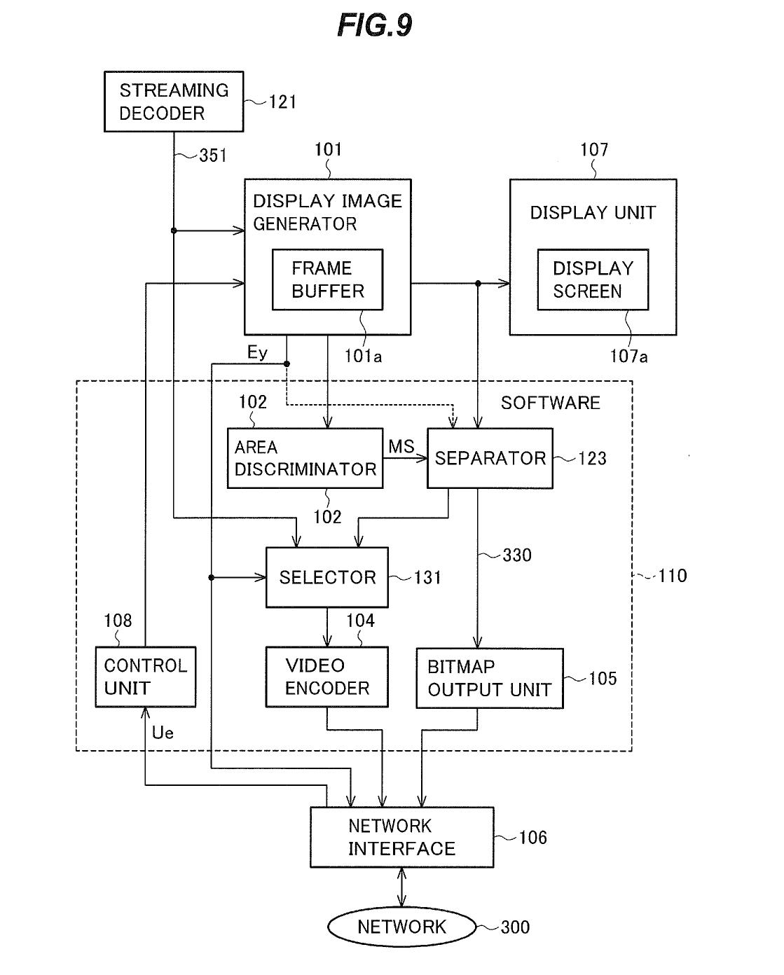

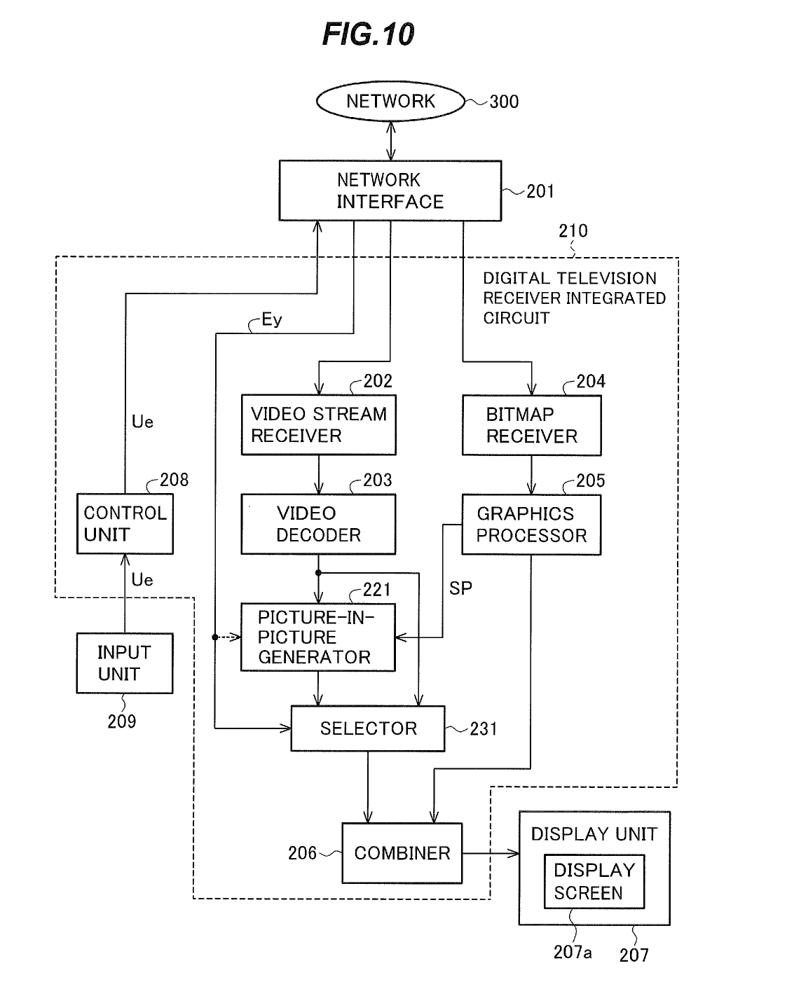

FIGS. 9 and 10 show the PC 100 and digital television receiver 200 in a remote display apparatus in a third embodiment of the invention. The illustrated PC 100 and digital television receiver 200 differ from the PC 100 and digital television receiver 200 in the second embodiment, described with reference to FIG. 6 and FIG. 7, in that a selector 131 is added to the PC 100 and a selector 231 is added to the digital television receiver 200.

Selector 131 receives information Ey indicating whether the display image generator 101 has enlarged the input moving picture and selects and outputs either data representing the moving picture output from the streaming decoder 121 or moving picture frame data output from the separator 103, according to the information Ey. If enlargement has been performed, the output of the streaming decoder 121 is supplied to the video encoder 104. If enlargement has not been performed, the moving picture frame data output from the separator 103 are supplied to the video encoder 104.

The information Ey indicating whether enlargement has been performed is also sent to selector 231 in the digital television receiver 200. Selector 231 outputs either the output of the picture-in-picture generator 221 or the output of the video decoder 203, according to the information Ey. If enlargement has been performed, the output of the picture-in-picture generator 221 is supplied to the combiner 206. If enlargement has not been performed, the output of the video decoder 203 is supplied to the combiner 206.

The information Ey indicating whether enlargement has been performed may also be sent to the picture-in-picture generator 221 in the digital television receiver 200, as indicated by the dotted arrow in FIG. 10, and if enlargement has not been performed, enlargement in the picture-in-picture generator 221 may be cancelled. The information Ey may also be sent to the separator 103, as indicated by the dotted arrow in FIG. 9, and if enlargement has been performed, the separator 103 may omit generating moving picture frame data. That is, the processing can be changed to fit the state of the image generated by the display image generator 101.

Those skilled in the art will recognize that further variations are possible within the scope of the invention, which is defined in the appended claims.

What is claimed is:

1. A remote display apparatus for displaying, on a display screen of a digital television receiver connected to an information processing device through a network, a display image generated for display on a display screen of the information processing device, wherein:
the information processing device
compressively encodes a moving picture frame data in which pixel values of pixels in a moving picture area in the display image are retained and pixel values of pixels in an area of the display image other than the moving picture area are replaced with a predetermined fixed value, and
sends the encoded moving picture frame data as a video stream to the network, and
sends bit mapped data representing a still picture area of the display image to the network; and
the digital television receiver
receives the video stream and the bit mapped data from the network,
decodes the received video stream and reproduces the image in the moving picture area,
reproduces the image in the still picture area from the received bit mapped data, and
combines the reproduced image in the moving picture area and the reproduced image in the still picture area to obtain a combined image and displays the combined image on a display unit of the digital television receiver.

2. The remote display apparatus of claim 1, wherein:
the information processing device has
a separator for generating the moving picture frame data, and still picture frame data in which the pixel values of pixels in the moving picture area in the display image are replaced with a value corresponding to a transparent part in graphics data and the pixel values of pixels in the area of the display image other than the moving picture area are retained,
a video encoder for generating the video stream by compressively encoding the moving picture frame data and outputting the video stream to the network, and
a bitmap output unit for outputting the still picture frame data generated by the separator to the network in a bit mapped data format; and
the digital television receiver has
a video decoder for decoding the video stream received from the network and outputting a decoded image,
a graphics processor for reproducing the image in the still picture area by converting the bit mapped data received from the network to a format suitable for display on the display screen of the digital television receiver, and
a combiner for combining the decoded image generated by the video decoder and the image in the still picture area reproduced by the graphics processor to generate the combined image.

3. A remote display apparatus for displaying, on a display screen of a digital television receiver connected to an information processing device through a network, a display image generated for display on a display screen of the information processing device, wherein:
an image in a moving picture area included in the display image has been obtained in the information processing device by enlargement of an original image;
the information processing device
compressively encodes data representing the original image and sends the encoded data to the network as a video stream, and
sends data representing a still picture area of the display image to the network as bit mapped data; and
the digital television receiver
receives the video stream and the bit mapped data from the network,
decodes the received video stream and enlarges the decoded stream by use of a picture-in-picture function, thereby reproducing the image in the moving picture area,
reproduces the image in the still picture area from the received bit mapped data, and
combines the reproduced image in the moving picture area and the reproduced image in the still picture area to obtain a combined image and displays the combined image on a display unit of the digital television receiver.

4. The remote display apparatus of claim 3, wherein:
the information processing device has
a video encoder for generating the video stream by obtaining and compressively encoding the data representing the original image, and outputting the video stream to the network,
a separator for outputting still picture frame data in which the pixel values of pixels in the moving picture area in the display image are replaced with a value corresponding to a transparent part in graphics data and the pixel values of pixels in the areas of the display image other than the moving picture area are retained, and
a bitmap output unit for outputting the still picture frame data generated by the separator to the network in a bit mapped data format;
the digital television receiver has
a video decoder for decoding the video stream received from the network and outputting a decoded image,
a picture-in-picture generator for processing the decoded image output from the video decoder as a sub-picture in a picture-in-picture, performing enlargement and positioning, and generating an image that has been enlarged and positioned,
a graphics processor for reproducing the image in the still picture area by converting the bit mapped data received from the network to a format suitable for display on the display screen of the digital television receiver, and
a combiner for combining the image generated by the picture-in-picture generator and the image in the still picture area reproduced by the graphics processor to generate the combined image; and
the picture-in-picture generator enlarges and positions the decoded image to match, in size and position, the transparent part of a frame represented by the still picture frame data.

5. A remote display apparatus for displaying, on a display screen of a digital television receiver connected to an information processing device through a network, a display image generated for display on a display screen of the information processing device, wherein:
the information processing device
decides whether an image in a moving picture area included in the display image has been obtained by enlargement of an original image in the information processing device;
compressively encodes data representing the original image and sends the encoded data to the network as a video stream, when the image in the moving picture area has been obtained by enlargement of the original image,
compressively encodes data representing the image in the moving picture area and sends the encoded data to the network as the video stream, when the image in the moving picture area has been obtained without enlargement of the original image, and
sends data representing a still picture area of the display image to the network as bit mapped data; and
the digital television receiver
receives the video stream and the bit mapped data from the network,
decodes the received video stream and enlarges the decoded stream by use of a picture-in-picture function, thereby reproducing the image in the moving picture area, when the image in the moving picture area has been obtained by enlargement of the original image,
decodes the received video stream, thereby reproducing the image in the moving picture area, when the image in the moving picture area has been obtained without enlargement of the original image,
reproduces the image in the still picture area from the received bit mapped data, and
combines the reproduced image in the moving picture area and the reproduced image in the still picture area to obtain a combined image and displays the combined image on a display unit of the digital television receiver.

6. The remote display apparatus of claim 5, wherein:
the information processing device has
a separator for generating moving picture frame data in which pixel values of pixels in the moving picture area in the display image are retained and pixel values of pixels in the areas of the display image other than the moving picture area are replaced with a predetermined fixed value, and generating still picture frame data in which the pixel values of pixels in the moving picture area in the display image are replaced with a value corresponding to a transparent part in graphics data and the pixel values of pixels in the areas of the display image other than the moving picture area are retained,
a first selector for selecting the data representing the original image when the image in the moving picture area has been obtained by enlargement of the original image, selecting the moving picture frame data when the image in the moving picture area has been obtained without enlargement of the original image, and outputting the selected data,
a video encoder for generating the video stream by compressively encoding the data selected by the first selector, and outputting the video stream to the network, and
a bitmap output unit for outputting the still picture frame data generated by the separator to the network in a bit mapped data format;
the digital television receiver has
a video decoder for decoding the video stream received from the network and outputting a decoded image,
a picture-in-picture generator for processing the decoded image output from the video decoder as a sub-picture in a picture-in-picture, performing enlargement and positioning, and generating an image that has been enlarged and positioned,
a second selector for selecting the image generated by the picture-in-picture generator when the image in the moving picture area has been obtained by enlargement of the original image, and selecting the decoded image output from the video decoder when the image in the moving picture area has been obtained without enlargement of the original image,
a graphics processor for reproducing the image in the still picture area by converting the bit mapped data received from the network to a format suitable for display on the display screen of the digital television receiver, and
a combiner for combining the image selected by the second selector and the image in the still picture area reproduced by the graphics processor to generate the combined image; and
the picture-in-picture generator enlarges and positions the decoded image to match, in size and position, the transparent part of a frame represented by the still picture frame data.

7. The remote display apparatus of claim 2, wherein an RFB protocol is used to send the still picture frame data from the information processing device to the digital television receiver.

8. The remote display apparatus of claim 2, wherein the video encoder performs compressive encoding based on an MPEG-2 standard.

9. The remote display apparatus of claim 2, wherein:
the still picture frame data include data for a GUI display;
the digital television receiver has an input unit for receiving user input performed in response to the GUI display;
the user input received by the input unit is sent to the information processing device; and
content of the GUI display is changed in the information processing device in response to the user input.

10. The remote display apparatus of claim 2, wherein:
the information processing device has an area discriminator for making a decision as to whether each area in the display image is a moving picture area or not; and
the separator generates at least one of the moving picture frame data and the still picture frame data on a basis of a result of the decision made by the area discriminator.
